(19) United States
(12) Patent Application Publication
(10) Pub. No.: US 2004/0068607 A1
(43) Pub. Date: Apr. 8, 2004

(54) Locking memory locations

(76) Inventor: Charles E. Narad, Los Altos, CA (US)

Correspondence Address: FISH & RICHARDSON, PC, 12390 EL CAMINO REAL, SAN DIEGO, CA, 92130-2081, US

(21) Appl. No.: 10/268,052

(22) Filed: Oct. 7, 2002

(51) Int. Cl. G06F 12/00; G06F 12/14

(52) U.S. Cl. 711/108; 711/163

(57) ABSTRACT

A mechanism for implementing CAM-based implicit mutual exclusion locks, with a RAM array being dynamically allocated to provide waitlists on elements in the CAM.

### BACKGROUND

When a computer program or execution thread needs to access a location in memory, it performs a memory reference instruction. When multiple threads of execution on one or more processors are sharing data, a mutual exclusion lock (“mutex”) is used to provide ownership of the shared data to only one agent at a time. The use of a mutex allows the thread that holds the mutex to make one or more modifications to the contents of a shared record, or a read-modify-write to update the contents, while maintaining consistency within that record.

### DESCRIPTION OF DRAWINGS

FIG. 1 is a block diagram of a communication system employing a multi-threaded processor.

FIG. 2A is a block diagram of content addressable memory (CAM) lock unit used by the multi-threaded processor to access memory.

FIG. 2B is an exemplary format of a CAM entry for the CAM lock unit.

FIG. 3 is an illustration of a single lock CAM entry and associated 2-deep waitlist.

FIG. 4 is a flowchart of the operation of the CAM lock unit when a read-lock request is processed.

FIG. 5 is a flowchart of the operation of the CAM lock unit when a write-unlock request is processed.

### DETAILED DESCRIPTION

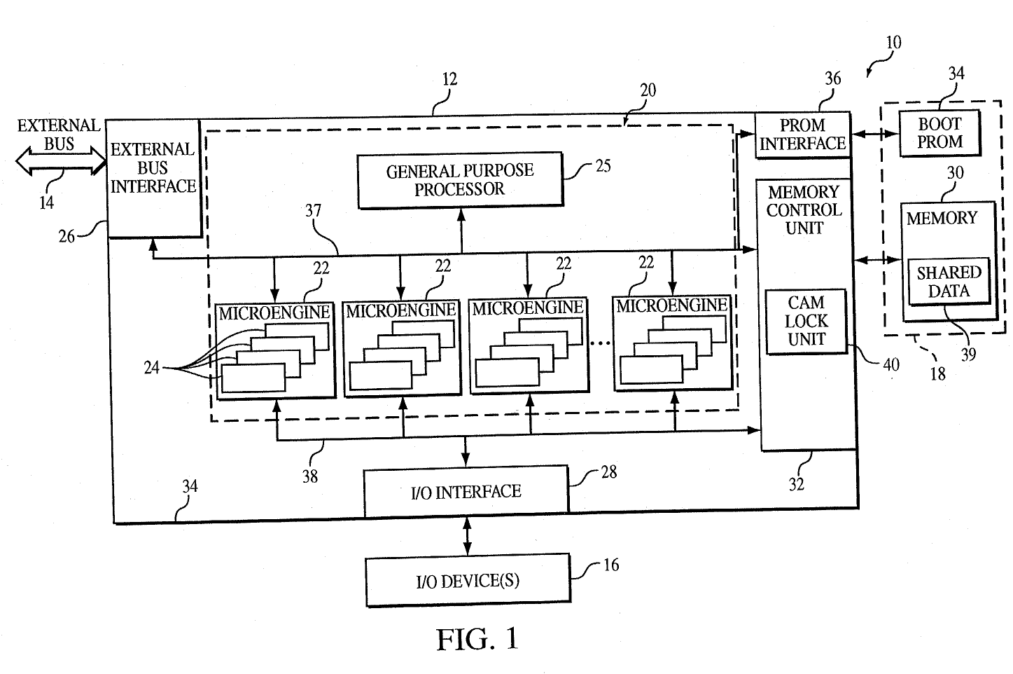

Referring to FIG. 1, a communication system 10 includes a processor 12 coupled to an external bus 14, one or more input/output (I/O) resources or devices 16 and a memory system 18. The processor 12 includes a multi-processor 20 that performs multiple processes in parallel, and is thus useful for tasks that can be broken into parallel subtasks. In other embodiments, this disclosure applies to a multithreaded and/or multi-processor system with communication through a shared memory.

In the embodiment shown, the multi-processor 20 includes multiple microengines 22, each with multiple hardware-controlled program threads 24 that can independently work on a task. The multi-processor 20 also includes a general purpose processor 25 that assists in loading microcode control for other resources of the processor 12, such as the microengines 22, and performs other general purpose computer type functions such as handling protocols, exceptions, and so forth. The general purpose processor 25 can use any supported operating system, preferably a real-time operating system. The microengines 22 each operate with shared resources including the memory system 18, a bus interface 26 and an I/O interface 28. The bus interface 26 provides an interface to the external bus 14, which may couple the processor 12 to a host or other device, e.g., another processor 12. The I/O interface 28 is responsible for controlling and interfacing the processor 12 to the I/O resources 16. The memory system 18 includes a random access memory (RAM) memory 30, which is accessed via a memory control unit 32, and a nonvolatile memory (shown as a programmable read-only memory (PROM)) 34, which is accessed via a PROM interface 36, that is used for boot operations.

The external bus interface 26, general purpose processor 25, microengines 22 and memory interfaces 36 and 32 are interconnected by a first bus structure 37. The microengines 22, memory interface 32 and I/O interface are interconnected by a second bus structure 38.

One example of an application for the processor 12 is as a network processor. In general, as a network processor, the processor 12 can interface to any type of communication device or interface that receives/sends large amounts of data. Thus, as a network processor, the I/O resources can be, for example, network media access controllers, media switch fabric interfaces, and the like, or if such devices are integrated with the I/O interface 28, then the networks and media switch fabrics. If communication system 10 functions in a networking application, it could receive a plurality of network packets from the I/O resources 16 and process those packets in a parallel manner. With the multi-threaded processor 20, each network packet can be independently processed.

A portion of the memory 30, usually implemented in dynamic random access memory (DRAM), is typically used for processing large volumes of data, e.g., processing of payloads from network packets. Another portion of the memory, which is usually implemented as higher speed static random access memory (SRAM), is used in a networking implementation for low latency, fast access tasks, e.g., accessing look-up tables and queue management functions. Much of the data stored in memory and, in particular, in SRAM, is shared data 39, that is, data that is used by various agents (e.g., the microengines 22 and the general purpose processor 25). Such shared data requires the protection of a mutual exclusive lock (“mutex”) when accessed. To provide such protection, the microengines 22 and general purpose processor 25 are configured to support “read-lock” and “write unlock” (or “unlock”) requests, and the memory control unit 32 uses a content addressable memory (CAM) lock unit 40 to assist in the processing of such requests. A read-lock on a particular memory location prevents other instructions from accessing that memory location until an unlock or a write-unlock instruction for that memory location is granted.

The read-lock, write-lock and unlock transactions may be triggered as special bus transactions that the agents are capable of issuing, e.g., a special instruction in a processor, or could be triggered as a side-effect of the value of unused address bits, a.k.a., “address aliasing”.

Although not shown, the memory control unit 32 includes data structures and logic, including address generation and command decode logic, to process memory reference requests. Each memory reference request is sent to the address generation and command decode logic where it is decoded and an address is generated. When the memory control unit 32 determines that a memory reference request is either a read-lock request, an unlock request or a write unlock request, it sends the generated address as well as an indication as to the type of operation to the CAM lock unit 40.

A CAM-based lock provided by the CAM lock unit 40 eliminates memory references required by conventional lock schemes as it combines the act of obtaining the lock with a read operation on at least one datum in the shared record using the read-lock operation, and can optionally combine the release of the lock with a write to the same datum using a write-unlock operation, or can simply use an explicit release using an unlock operation. Instead of locking the shared data by obtaining an associated lock at different location in some memory, the CAM-based locking of the CAM lock unit 40 uses a CAM to maintain a list of all addresses that are currently locked, and a separate per-lock ordered waitlist for each locked location when at least one requester is waiting to read-lock that same location, as will be described.

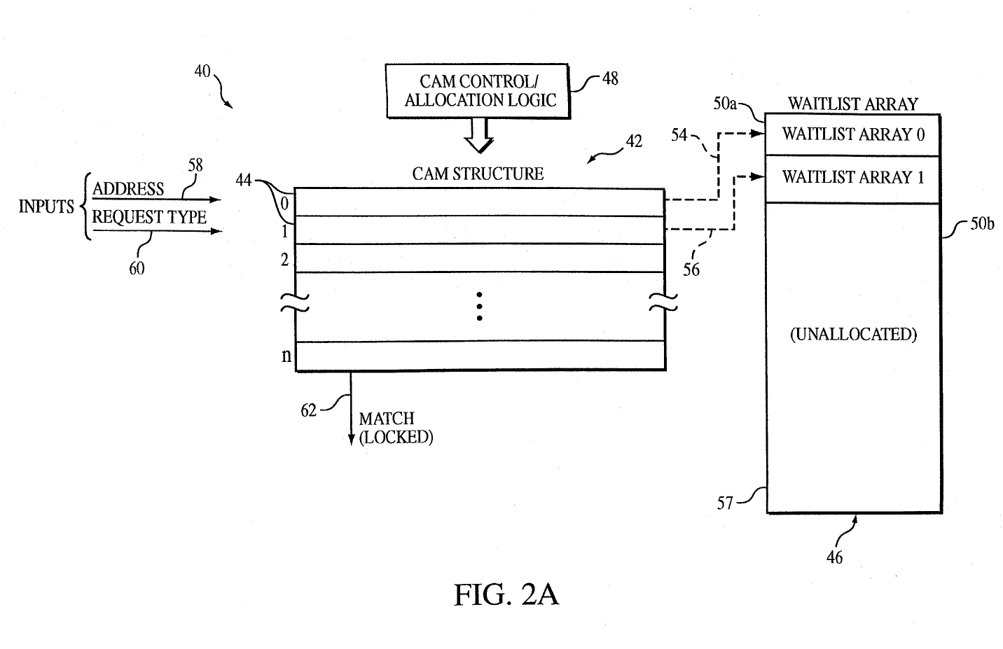

Referring to FIG. 2A, the CAM lock unit 40 includes a CAM structure or array 42 having entries 44. There are enough entries available that it is possible for all “n” requesters or agents in the system to each be holding one concurrently. If, for example, there are 8 microengines with 4 context threads each, then the total number of such agents (including the general purpose processor) would be 33. In some embodiments, each thread and the general purpose processor (GPP) can hold a single CAM lock at any time. In other embodiments, these entities can hold multiple CAM locks at any time. Attempting to obtain a CAM lock while already holding one can result in the access being dropped and/or an error indication to the requester and/or the GPP.

Also included is a waitlist array 46, portions of which are allocated to the CAM entries when such entries are written with data. The waitlist array 46 for the CAM entries can be a single RAM or register array. The waitlist array 46 has enough entries such that all possible requesters could also be waiting on one lock, or any combination of requesters can each be waiting for one lock or there can be a list of requesters per currently held lock, excluding of course those requesters that are holding locks at that time.

Further included in the CAM lock unit 40 is CAM control/allocation logic 48, which performs the necessary CAM array scans for matches, as well as allocating the CAM entries to store lock request information and associated waitlist arrays. For example, if entry 0 and entry 1 each maintain lock request data, the CAM control logic 48 will have allocated portions of the waitlist array, waitlist array 50a and waitlist array 50b, to entry 0 and entry 1, respectively, as indicated by the dashed lines 54 and 56. If only entries 0 and 1 contain lock information, the remaining portion 57 of the waitlist array is unallocated. The logic 48 allocates, as needed, entries in a waitlist array from which a linked list (or other data structure) of waiting transactions/requesters for each currently locked entry can be constructed. Consequently, it is not necessary to over-provision by making the RAM as large as (the number of CAM entries)×(the maximum number of requesters). Also, because each waitlist operates independently, pending requests are not subject to false head-of-line blocking due to contention with other, unrelated waiting requests.

As indicated earlier, the CAM lock unit 40 receives as input, an address 58 and indication of request type 60. As an output, the unit 40 provides a matched (or locked) result 62 to indicate whether or not the address corresponds to a location for which a lock is already held by a prior requester.

Referring to FIG. 2B, each entry 44 includes a tag field 62 that identifies the address of a locked memory location, along with a first data field 64 to indicate the identity (ID) of the current owner of the lock (Owner ID) (e.g., a thread ID) and a second data field 66 to indicate the identity of the most recent requester for that lock (Tail ID). Also included is a “valid” (or “V”) bit 67 and a “next valid” (or “NV”) bit 68. The NV bit 68 is used to indicate if there is at least one entry on the waitlist for this lock. This information may be implicit if the Owner ID 64 is not the same as the Tail ID 66. Thus, these two fields can be compared or an explicit NV bit can be provided to give the same information. The waitlist array 46 is used to construct linked lists of IDs waiting for access to each locked location. The waitlist array 46 is indexed by requester ID value.

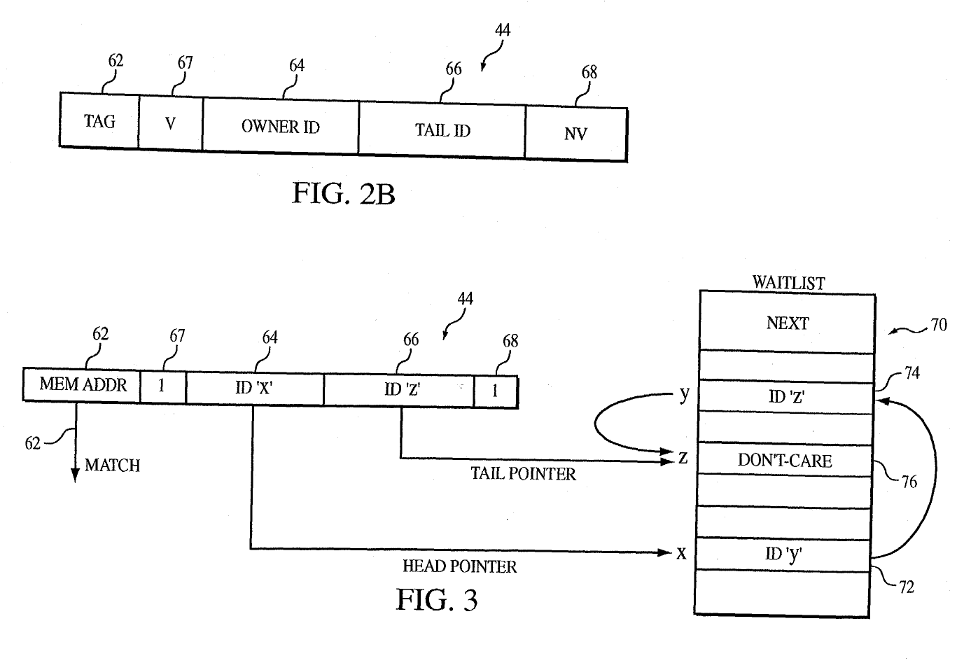

FIG. 3 shows an exemplary CAM entry 44 and associated 2-entry (2 deep) waitlist 70 constructed from a waitlist array 50 allocated to that CAM entry. As shown, the tag field 62 contains an address of a locked memory location, the V bit and NV bit are set in respective fields 67 and 68, the Owner ID in field 64 contains the ID ‘x’ and the Tail ID in field 66 contains the ID ‘z’. The ID ‘x’ serves to point to the first waitlist entry (head of the waitlist) 72, which contains ID ‘y’. The ID ‘y’ points to the next entry 74 containing ID ‘z’, the last entry on the list. The ID ‘z’ in the waitlist entry y as well as in the Tail ID field 66 points to the tail of the waitlist, a “don't care” entry 76. It will be appreciated from this example that the ID values ‘x’, ‘y’ and ‘z’ are used to index the waitlist array locations. Thus, the current linked list of waiting requesters is formed by following the head pointer (Owner ID) and subsequent waitlist entry ID values. The Tail ID is used as an insertion pointer to add a new ID value to the linked list which implements the waitlist for that particular linked entry.

A thread executes a read-lock operation with a data size of 1-16, 32-bit words and goes to sleep on the read completion. If the starting address is already in the CAM, this request is put into the waitlist queue for that lock until sometime later after the CAM entry is released by its current owner using a write-lock or an unlock. If the address is not in the CAM, it is put there along with the associated tag information and the requested data is returned to the thread.

The general purpose processor 25 accesses the locks by reading and writing to the sram_lock alias space to implement read-lock and write-unlock. To implement a simple unlock, the processor writes the address as data to a CSR in the memory control unit 32.

Each lock is held and compared to a precise word-aligned memory address. By using a burst when locking an entry, the CAM locks allow access to a contiguous protected region without needing additional memory references to obtain and release a mutex. Larger regions can also be covered by this implicit mutex by mutual agreement in the software. The benefit of the CAM locks is that they create an implied mutex_enter ( ) and mutex_exit ( ) on shared memory data without the extra two memory reference transfers to an explicit mutex location.

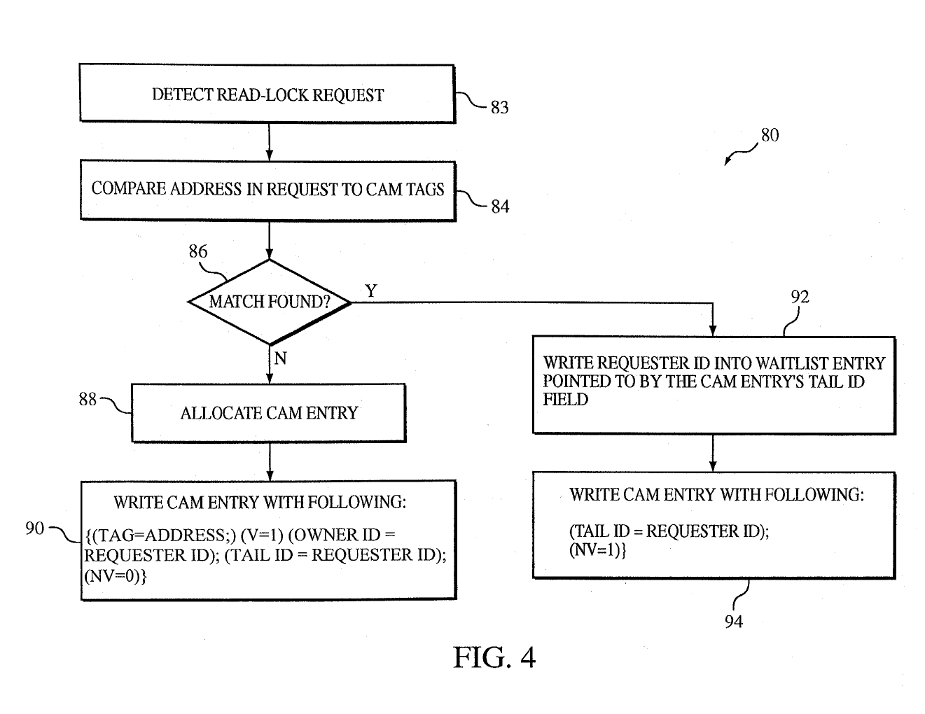

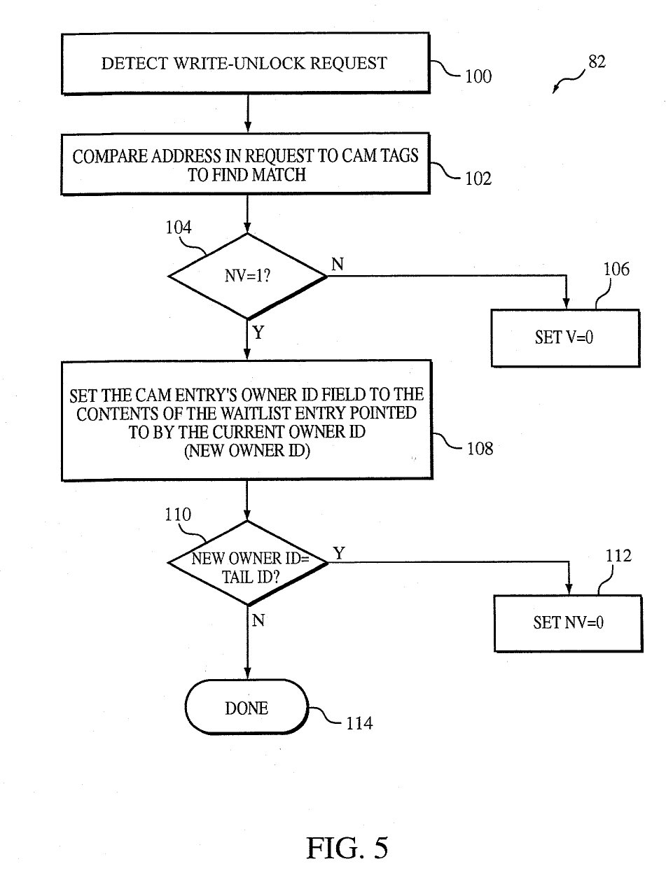

The operation of the CAM lock unit 40 will now be described with reference to FIGS. 4 and 5. FIG. 4 illustrates the read-lock request processing 80 performed by the CAM lock unit 40 when a read-lock operation is requested. FIG. 5 illustrates the unlock request processing 82 performed by the CAM lock unit 40 when a write-unlock operation or unlock operation is requested.

Referring to FIG. 4, when the CAM lock unit 40 detects 83 a read-lock request, the unit compares 84 the address to the CAM array contents, that is, the tags stored in the CAM array 42. If the unit determines 86 that no match is found, the CAM lock unit allocates 88 a CAM entry and associated waitlist, and writes 90 the CAM entry with information. More specifically, the address is stored in the tag field, the valid bit is set (Valid=‘1’), the ID of the requester is stored in the Owner ID and the Tail ID field, and the next valid bit is set to zero (NV ‘0’).

If, at 84, a match is found, that is, a lock is already being, held for the address, the CAM lock unit 40 writes 92 the ID of the requester into the waitlist entry pointed to by the current Tail ID field of the matched CAM entry. The CAM lock unit 40 also writes 94 the Tail ID field with the new requestor's ID and sets Next Valid (NV=‘1’) in the CAM entry containing the matching address. At this point, the new request is appended to the tail of a linked list (waitlist) of waiting requesters for that lock.

Referring to FIG. 5, when the CAM lock unit 40 detects 100 an unlock or write-unlock request, the CAM lock unit 28 compares 102 the address to the CAM tags to find a match. Upon finding the match, the CAM lock unit 40 checks 104 the Next Valid field to determine if at least one entry is waiting for this lock, that is, is the NV bit set (NV=‘1’). If the value of NV is not equal to one, there are no requesters waiting on the lock. The CAM lock unit 40 sets 106 the valid bit to zero (V=‘0’) for the entry. On the other hand, if (NV=‘1’), then there is at least one requester waiting on the lock. In that case, the CAM lock unit 40 sets 108 that entry's Owner ID to the contents of the waitlist array entry pointed to by the current owner ID (follows the linked list). The CAM lock unit 40 determines 110 if the new owner ID equals the Tail ID (thus indicating no more requesters waiting). If so, it clears 112 the NV bit for that entry 114. Otherwise, it completes 114 without adjusting the NV field setting.

Thus, when an address is released by the current owner, the oldest member of the waitlist for that address is graduated to being its current owner. If the waitlist for the address is empty, the released address is effectively removed from the CAM by clearing the valid bit.

By providing sufficient capacity to enable requesters to be holding a lock simultaneously, and by making the waitlist for any one lock location such that it holds only requests for that location, contention delays that might result from the use of a single waitlist for all locations may be avoided except for the legitimate ones, i.e., when the location is currently locked by some other agent and that there may be others who requested ownership of that location prior to this request. The CAM lock unit 40 thus provides an efficient CAM lock mechanism in an environment where no agent is allowed to hold more than one CAM-locked entry at any one time.

Other embodiments are within the scope of the following claims.

What is claimed is:

1. A method comprising:
searching a content addressable memory (CAM) having a number of entries usable to identify locked memory locations to determine if a read-lock memory reference request is requesting access to a memory location that matches one of the locked memory locations; and
placing the read-lock memory reference request in a waitlist for an entry identifying a matched one of the locked memory locations if a match is found.

2. The method of claim 1, wherein placing comprises reading information in the entry to locate a waitlist entry at the end of the waitlist.

3. The method of claim 1 wherein the waitlist is indexed by requester ID values.

4. The method of claim 1 wherein each CAM entry is defined to include a tag field to indicate an address of a memory location that has a lock, an owner ID field to store an owner ID corresponding to a requester that currently owns the lock and a tail ID field to store tail ID corresponding to a most recent requester of the lock.

5. The method of claim 4 wherein the owner ID points to the head of the waitlist and the tail ID points to the tail of the waitlist.

6. The method of claim 4 wherein placing further comprises setting the tail ID to an ID of the requester of the read-lock memory reference request.

7. The method of claim 6 wherein the validity of the tail ID is indicated with a tail ID valid bit.

8. The method of claim 6 wherein the validity of the tail ID is detected when tail ID is not equal to owner ID.

9. The method of claim 1 further comprising allocating one of the content addressable memory entries to the read-lock memory reference request if no match is found.

10. The method of claim 9 further comprising associating a waitlist with the allocated entry.

11. The method of claim 9 further comprising storing in the allocated entry an address of the memory location to which the read-lock memory reference request requests access, and a requester ID for the read-lock memory reference request in a owner ID field and a tail ID field.

12. The method of claim 4 further comprising searching the entries to find a content addressable memory entry storing in the tag field therein a locked location specified in an unlock memory reference request

13. The method of claim 1 further comprising:
determining if there are one or more entries on a waitlist associated with the content addressable memory entry; and
if there are not one or more entries on the waitlist, indicating in the content addressable memory entry that the content addressable memory entry is available for allocation to a new read-lock memory reference request.

14. The method of claim 1 further comprising:
if there are one or more entries on the waitlist, changing an owner of the content addressable memory entry to a requester in the waitlist.

15. The method of claim 13 wherein determining if there are one or more entries in the waitlist comprises reading information stored in the content addressable memory entry.

16. The method of claim 1 wherein each entry storing a locked location is associated with a waitlist array from which a waitlist is constructed, and memory for each waitlist array is allocated from a single waitlist array.

17. The method of claim 16 wherein the waitlist array for an entry contains a number of entries based on a number of agents that may execute the read-lock memory reference requests.

18. The method of claim 1 wherein the number of content addressable memory entries is as great as the number of possible requesters of read-lock memory reference requests.

19. An article comprising:
a storage medium having stored thereon instructions that when executed by a machine result in the following:
searching a content addressable memory having a number of entries usable to identify locked memory locations, to determine if a read-lock memory reference request is requesting access to a memory location that matches one of the locked memory locations; and
placing the read-lock memory reference request on a waitlist for a matched one of the locked memory locations if a match is found.

20. The article of claim 19 wherein each entry includes a tag field to indicate an address of a memory location that has a lock, an owner ID field to store an owner ID corresponding to a requester that currently owns the lock and a tail ID field to store a tail ID corresponding to a most recent requester of the lock.

21. The article of claim 19 wherein the storage medium further stores instructions that when executed by the machine result in:
determining if there are one or more entries on a waitlist associated with the content addressable memory entry; and
if there are not one or more entries on the waitlist, indicating in the content addressable memory entry that the content addressable memory entry is available for allocation to a new read-lock memory reference request.

22. The article of claim 19 wherein the storage medium further stores instructions that when executed by the machine result in:
if there are one or more entries on the waitlist, changing an owner of the content addressable memory entry to a requester in the waitlist.

23. A controller comprising:
a content addressable memory lock unit having an array of entries usable to identify locked memory locations; and
control logic to associate the entries with waitlists that list read-lock memory reference requests that await access to the memory locations to which the entries correspond.

24. The controller of claim 23 wherein each entry is defined to include a tag field to indicate an address of a memory location that has a lock, an owner ID field to store an owner ID corresponding to a requester that currently owns the lock and a tail ID field to store a tail ID corresponding to a most recent requester of the lock.

25. The controller of claim 23, wherein the control logic comprises logic to assign ownership of an entry to an owner identified in a waitlist for the entry.
